(19) United States
(12) Patent Application Publication
(10) Pub. No.: US 2021/0376324 A1
(43) Pub. Date: Dec. 2, 2021

(54) BATTERY MATERIALS

(71) Applicant: Sumitomo Chemicao Comical Company Limeted, Tokyo (JP)

(72) Inventors: Florence Bourcet, Cambridge (GB); Jean-Benoit Giguere, Cambriudrg (GB); Thomas Kugler, Cambridge (GB)

(73) Assignee: Sumitomo Chemicao Comical Company Limeted, Tokyo (JP)

(21) Appl. No.: 17/041,343

(22) PCT Filed: Mar. 21, 2019
(86) PCT No.: PCT/GB2019/050794

§ 371 Date: Sep. 24, 2020

(30) Foreign Application Priority Data
Mar. 27, 2018 (GB) 18064917.1

(51) Int. Cl. H01M 4/60; H01M 10/0569; H01M 4/62; C08G 12/08

(52) U.S. Cl. CPC H01M 4/606; C08G 12/08; H01M 4/625; H01M 10/0569

(57) ABSTRACT

A battery cell formed of anode made from an n-type polymer and a cathode made from a p-type polymer with an electrolyte between the anode and the cathode. The anode and cathode are formed by depositing a compound that contains a non-volatile electrolyte that creates pathways in the deposited anode and the cathode. The n-type polymer and the p-type polymer are polymers that include a repeat unit of the following formula:

### BACKGROUND

Embodiment of the present invention relate to battery cells, polymers, compositions and formulations for forming battery cells.

Use of a conjugated polymer in the anode or cathode of a polymer-based battery cell is disclosed in, for example, Journal of Power Sources, Volume 177, Issue 1, 15 Feb. 2008, Pages 199-204, in Chem. Rev. 2016, 116, 9438-9484 and in Chemical Reviews, 1997, Vol. 97, No. 1 209.

Batteries containing Schiff base polymers are disclosed in WO2009003224 and WO2012145796.

Aromatic Azomethine Polymers and Fibers, Paul W. Morgan, Stephanie L. Kwolek, and Terry C. Pletcher, Macromolecules, 1987, 20 (4), pp 729-739 describes the synthesis and detailed characterization of conjugated aromatic polyimines with various backbone and side-group substitution structures.

### SUMMARY

In some embodiments of the present disclosure, a polymer is provided that increases the discharge voltage of a polymer battery.

In a first aspect, some embodiments of the present disclosure provide a battery cell comprising an anode comprising an n-type polymer, a cathode comprising a p-type polymer and an electrolyte between the anode and the cathode wherein at least one of the n-type polymer and the p-type polymer comprises a repeat unit of formula (I),

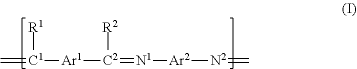

where:

R¹ and R² are each independently selected from the group consisting of hydrogen and C₁₋₂₀ alkyl wherein one or more non-adjacent, non-terminal C atoms of the alkyl may be replaced with O, CO or COO;

Ar¹ and Ar² are each independently an aromatic or heteroaromatic group which is unsubstituted or substituted with one or more substituents and at least one of Ar¹ and Ar² is selected from a group of formula (II) or a group of formula (III):

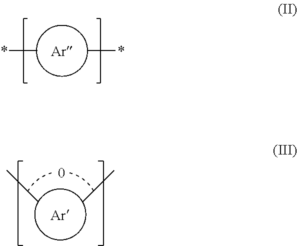

where:

Ar′ is an aromatic or heteroaromatic group which is unsubstituted or substituted with one or more substituents and θ is a bond angle which is not 180°; and

Ar″ is an aromatic or heteroaromatic group comprising two or more fused rings which is unsubstituted or substituted with one or more substituents and the linkages * of Ar″ are on different rings.

In a second aspect, some embodiments of the present disclosure provide a composition comprising a polymer according to the first aspect and one or more materials selected from the group comprising conductive carbon, electrolyte, binding agents, and an n-type polymer other than a polymer according to the first aspect.

In a third aspect, some embodiments of the present disclosure provide a polymer comprising a repeat unit of formula (I),

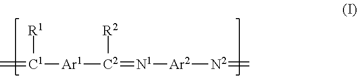

where:

R¹ and R² are each independently selected from the group consisting of hydrogen and C₁₋₂₀ alkyl wherein one or more non-adjacent, non-terminal C atoms of the alkyl may be replaced with O, CO or COO;

Ar¹ and Ar² are each independently an aromatic or heteroaromatic group which is unsubstituted or substituted with one or more substituents and at least one of Ar¹ and Ar² is selected from a group of formula (III):

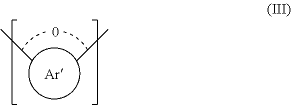

wherein Ar′ is an aromatic or heteroaromatic group which is unsubstituted or substituted with one or more substituents and θ is a bond angle which is not 180°.

In a fourth aspect, some embodiments of the present disclosure provide a formulation comprising a composition according to the second aspect dispersed in one or more solvents.

In a fifth aspect, some embodiments of the present disclosure provide a method of forming a battery cell according to the embodiments of the first aspect, the method comprising the step of applying a formulation according to the fourth aspect onto a surface of a current collector and evaporating the one or more solvents.

### DESCRIPTION OF THE DRAWINGS

The invention will now be described in more detail with reference to the drawings in which:

FIG. 1 illustrates a polymer battery cell according to an embodiment;

FIG. 2 is a plot of voltage vs specific capacity at a current density of 0.1 mA/cm² in battery cells according to embodiments and a comparative battery cell; and

FIG. 3 illustrates a conjugation path of alternating single and double bonds across a para-phenylene unit linked to adjacent aromatic groups and the absence of a conjugation path across a meta-phenylene unit.

### DETAILED DESCRIPTION

In some embodiments, at least one of the n-type polymer and p-type polymer is a polymer comprising a repeat unit of formula (I):

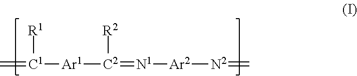

where:

R¹ and R² are each independently selected from the group consisting of hydrogen and C₁₋₂₀ alkyl wherein one or more non-adjacent, non-terminal C atoms may be replaced with O, COO or CO,

Ar¹ and Ar² are each independently aromatic or heteroaromatic groups which are each unsubstituted or substituted with one or more sub stituents, and

at least one of A¹ and Ar² is selected from a group of formula (II) or a group of formula (III):

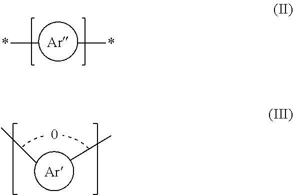

wherein Ar′ is an aromatic or heteroaromatic group which is unsubstituted or substituted with one or more substituents and θ is a bond angle which is not 180°; and Ar″ is an aromatic or heteroaromatic group comprising two or more fused rings which is unsubstituted or substituted with one or more substituents and each linkage * is on a different ring.

By “non-terminal carbon atom” of an alkyl chain as used herein is meant a carbon atom other than the carbon atom of a methyl group of an n-alkyl chain, or carbon atoms of a methyl group of a branched alkyl chain.

Where present, a substituent of Ar¹ or Ar² is optionally selected from: a linear, branched or cyclic C₁₋₁₂ alkyl group wherein one or more non-adjacent, non-terminal C atoms of the C₁₋₁₂ alkyl group may be replaced with O; an aromatic group, preferably phenyl, which may be unsubstituted or substituted with one or more substituents selected from linear, branched or cyclic C₁₋₁₂ alkyl groups wherein one or more non-adjacent, non-terminal C atoms of the C₁₋₁₂ alkyl group may be replaced with O; and ionic groups, preferably a cationic group.

Ar¹ and Ar² are each preferably a C₆₋₂₀ arylene group. Preferably, Ar¹ is unsubstituted. Preferably, Ar² is unsubstituted. Optionally, each R¹ is an aliphatic substituent having no more than 12 atoms, optionally no more than 10 atoms.

Examples of ionic groups include a group of formula -(Sp)_{q}-COO⁻M⁺ wherein Sp is a branched or linear C₁₋₁₂ alkylene spacer group in which one or more non-adjacent C atoms may be replaced with O; q is 0 or 1; and M⁺ is a cation, preferably an alkali or N(R⁹)₄⁺ wherein R⁹ is H or C₁₋₁₂ alkyl.

Bond angle θ of the group of formula (III) may be the bond angle as measured by X-ray crystallography of a monomer containing the group of formula (III).

Ar¹ and Ar² may be arranged in a cis- or trans- configuration with respect to the C²═N¹ double bond and the C¹═N² double bond. Ar¹ and Ar² are preferably arranged in a trans-configuration with respect to at least one of the C²═N¹ double bond and the C¹═N² double bond, and are preferably in a trans arrangement with respect to both double bonds as illustrated below:

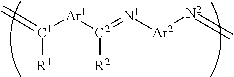

All repeat units of the polymer may be repeat units of formula (I) or the polymer may comprise further co-repeat units.

In some embodiments, Ar¹ and Ar² are each independently a group of formula (II) or (III). Preferably, only one of Ar¹ and Ar² is a group of formula (II) or (III). In some preferred embodiments, Ar¹ is para-phenylene. Ar² according to these embodiments is either a group of formula (II) or (III). In some preferred embodiments, Ar² is para-phenylene. Ar¹ according to these embodiments is either a group of formula (II) or (III).

Preferably, the group of formula (III) has formula (IIIa) or formula (IIIb), more preferably formula (IIIa):

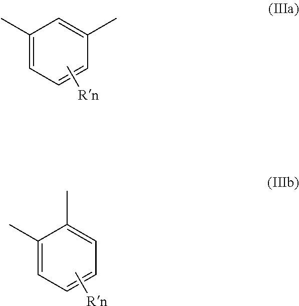

where: R′ in each occurrence is independently a substituent which may be selected from substituents of A¹ and Ar² as described above, and n is 0 or a positive integer. In the case where n is a positive integer, it may be 1, 2, 3 or 4, more preferably 1 or 2.

Preferably, the group of formula (II) has formula (IIa):

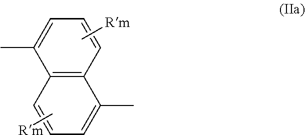

where: R′ in each occurrence is independently a substituent as described above and m in each occurrence is independently 0 or a positive integer.

In the case where m is a positive integer, it may be 1, 2 or 3, more preferably 1 or 2.

A preferred group of formula (II) is 1,5-linked naphthalene. Preferably, θ is 60° or 120°. Optionally, the repeat unit of formula (I) is a non-conjugating repeat unit.

A non-conjugating repeat unit as described herein is a repeat unit which may be conjugated to adjacent repeat units in the polymer backbone, and is preferably directly linked and conjugated to arylene or heteroarylene groups of adjacent repeat units in the polymer backbone, but which does not provide a conjugation path across the repeat unit, in particular a repeat unit that does not provide a path of alternating saturated and unsaturated bonds between repeat units adjacent to the non-conjugating repeat unit.

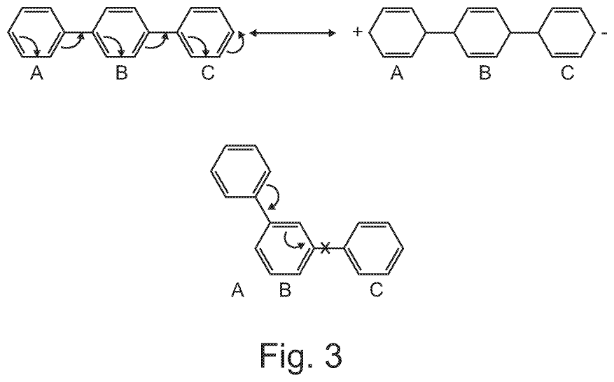

As illustrated in FIG. 3, a 1-4-linked phenylene unit B provides a conjugation path of alternating single and double bonds between adjacent aromatic units A and C, whereas a 1,3 linked phenylene unit B is conjugated to adjacent aromatic units A and C but does not provide a conjugation path between these units. Repeat units of formula (I) may make up 0.1-100 mol % of the repeat units of the polymer, more preferably 10-100 mol %. Optionally, repeat units of formula (I) are the only repeat units of the polymer.

Polymers comprising a repeat unit of formula (I) may be formed by the following method:

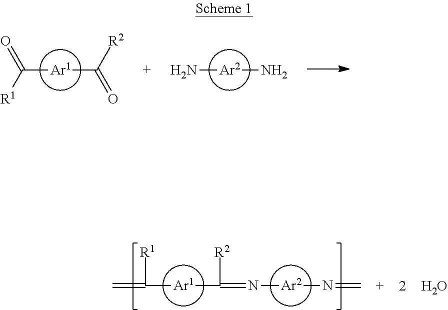

Schiff-base polymers may be synthesized according to the methods described in Aromatic Azomethine Polymers and Fibers, Paul W. Morgan, Stephanie L. Kwolek, and Terry C. Pletcher, Macromolecules, 1987, 20 (4), pp 729-739.

A composition according to the present invention comprises a polymer comprising a repeat unit of formula (I) and one or more materials selected from the group comprising conductive carbon, electrolyte, binding agents, and an n-type polymer other than a polymer comprising a repeat unit of formula (I).

Preferably, the electrolyte is an ionic electrolyte. Preferably, the conductive carbon is carbon black. Preferably the composition comprises at least 1 wt. % of the polymer comprising a repeat unit of formula (I), preferably between 20-95 weight percent, more preferably 40-95 weight %.

A polymer according to the present invention a polymer comprises a repeat unit of formula (I),

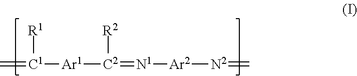

where:

R¹ and R² are each independently selected from the group consisting of hydrogen and C₁₋₂₀ alkyl wherein one or more non-adjacent, non-terminal C atoms of the alkyl may be replaced with O, CO or COO;

Ar¹ and Ar² are each independently an aromatic or heteroaromatic group which is unsubstituted or substituted with one or more substituents and at least one of Ar¹ and Ar² is selected from a group of formula (III):

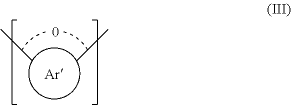

where: Ar′ is an aromatic or heteroaromatic group which is unsubstituted or substituted with one or more substituents and θ is a bond angle which is not 180°.

All definitions and preferred features of the polymer, the repeat unit of formula (I), R¹, R², C¹, C², N¹, N², Ar¹ and Ar² of the polymer of the present invention may be as described in relation to the polymer of the battery cell according to the present invention, except when said definitions and preferred features relate exclusively to formula (II).

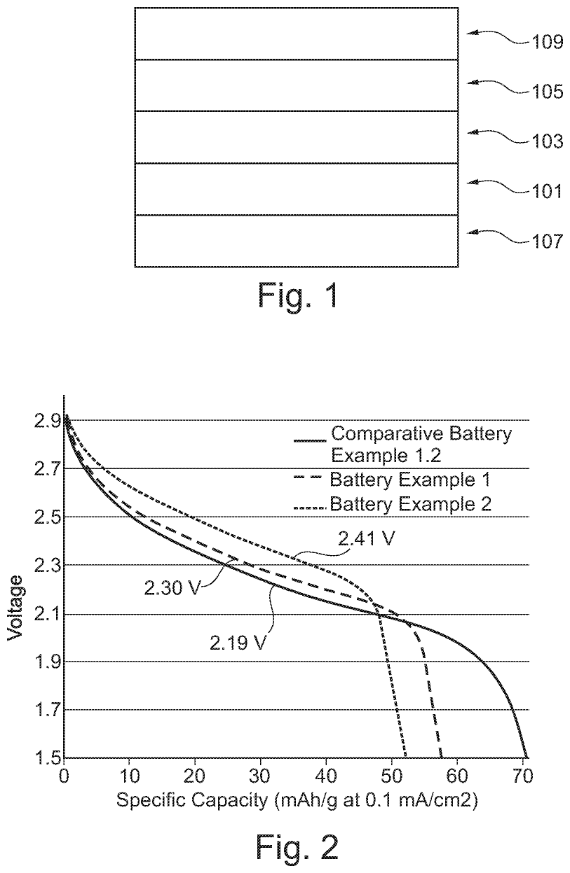

FIG. 1 illustrates a battery cell 100 according to an embodiment comprising an anode 101, a cathode 105, a separator 103 between the anode and the cathode, an anode current collector 107 in contact with the anode and a cathode current collector 109 in contact with the cathode. A liquid electrolyte is absorbed in the separator. In other embodiments, the electrolyte may be a crosslinked polymer electrolyte, in which case a separator distinct from the crosslinked polymer electrolyte may or may not be present. The crosslinked polymer electrolyte may be a solid or a gel.

The anode comprises a polymer which is capable of undergoing reversible n-doping (an “n-type” polymer). n-type polymers as described herein preferably have a LUMO level measured by square wave voltammetry of between −4.5 and −1.5 eV, more preferably between −3.5 and −2.0 eV.

The cathode comprises a polymer which is capable of undergoing reversible p-doping (a “p-type” polymer). The p-type polymers as described herein preferably have a HOMO level measured by square wave voltammetry of between −4.5 and −6.5 eV, more preferably between −4.8 and −6 eV. At least one of the n-type and p-type polymers, optionally both of the n-type and p-type polymers, is a polymer comprising a repeat unit of formula (I).

A polymer battery as described herein may comprise an n-type polymer comprising repeat units of formula (I) and a p-type polymer which does not comprise a repeat unit of formula (I). A p-type polymer which does not comprise a repeat unit of formula (I) may comprise or consist of one or more amine repeat units, and optionally one or more arylene repeat units.

A polymer battery as described herein may comprise a p-type polymer comprising repeat units of formula (I) and an n-type polymer which does not comprise a repeat unit of formula (I). An n-type polymer which does not comprise a repeat unit of formula (I) may comprise or consist of one or more 5-20 membered monocyclic or polycyclic heteroaromatic repeat units comprising one or more N atoms, and optionally one or more arylene repeat units. Heteroaromatic repeat units comprising one or more N atoms may comprise 0.1-99 mol % of the repeat units of the polymer, more preferably 10-75 mol %.

Heteroaromatic repeat units comprising one or more N atoms include, without limitation, pyridine, quinoline, benzothiadiazole, benzotriazole and triazine each of which may be unsubstituted or substituted with one or more substituents, optionally one or more substituents selected from R¹ as described above.

A particularly preferred heteroaromatic repeat unit is a repeat unit of formula (IV):

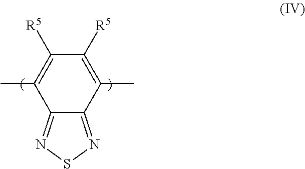

where R⁵ in each occurrence is the same or different and is H or a substituent.

Optionally, each R⁵ is independently selected from the group consisting of: F, CN; NO₂; C₁₋₂₀ alkyl wherein one or more non-adjacent, non-terminal carbon atoms may be replaced with O, S, —Si(R⁹)₂—C═O or COO wherein R⁹ in each occurrence is independently a substituent, preferably a C₁₋₂₀ hydrocarbyl group; and a group of formula —(Ar¹)m wherein Ar¹ in each occurrence is an aryl or heteroaryl group, preferably phenyl, which is unsubstituted or substituted with one or more substituents and m is at least 1, optionally 1, 2 or 3.

Substituents of Ar⁴, if present, are preferably selected from C¹⁻²⁰ alkyl wherein one or more non-adjacent, non-terminal carbon atoms may be replaced with O, S, —Si(R⁹)₂—C═O or COO. Amine repeat units of a p-type polymer not comprising a repeat unit of formula (I) suitably comprise a N atom in the polymer backbone, for example as disclosed in WO 99/54385, the contents of which are incorporated herein by reference.

Amine repeat units as described herein may have formula (V) or (VI):

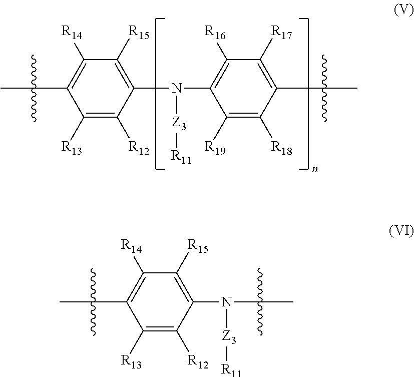

where:

R₁₁ to R₁₉ are independently selected from hydrogen, C₁₋₂₀-alkyl, C₁₋₂₀-alkyl ether, C₁₋₂₀-carboxyl, C₁₋₂₀-carbonyl, C₁₋₂₀-ester, C₆₋₁₈-aryl, C₅₋₁₈-heteroaryl;

n is greater than or equal to 1 and preferably 1 or 2; and

Z₃ is selected from a single bond, C₁₋₂₀-alkylene, optionally substituted C₆₋₁₈-arylene, or an optionally substituted C₅₋₁₈-heteroarylene group.

In preferred embodiments, R₁₂ to R₁₉ are independently selected from hydrogen, C₁₋₁₂-alkyl, C₁₋₁₂-alkyl ether, C₁₋₁₂-carboxyl, C₁₋₁₂-carbonyl, C₁₋₁₂-ester, optionally substituted C₆₋₁₂-aryl, and optionally substituted C₅₋₁₂-heteroaryl groups; Z₃ is selected from a single bond, an optionally substituted C₁₋₁₂-alkylene, optionally substituted C₁₋₁₂-oxyalkylene, optionally substituted C₆₋₁₂-arylene, or an optionally substituted C₆₋₁₂-heteroarylene group. Where present, substituents of a C₆₋₁₂-arylene, or a C₆₋₁₂-heteroarylene group Z₃ are optionally selected from C1-20 alkyl in which one or more non-adjacent, non-terminal C atoms may be replaced with O. In one embodiment, Z₃ is an optionally substituted phenylene group, with the residue R₁₁ being preferably an oligo- or polyether group having at least two alkoxy repeat units and being located in m- or p-position relative to the arylamino group.

A preferred amine repeat unit is 4,4′-linked triphenylamine which may be unsubstituted or substituted with one or more substituents as described above. Amine repeat units may make up 0.1-100 mol % of the repeat units of a p-type polymer not comprising a repeat unit of formula (I), more preferably 50-100 mol %.

Arylene repeat units of n-type or p-type polymers not comprising a repeat unit of formula (I) include, without limitation, repeat units of formulae (VII)-(IX):

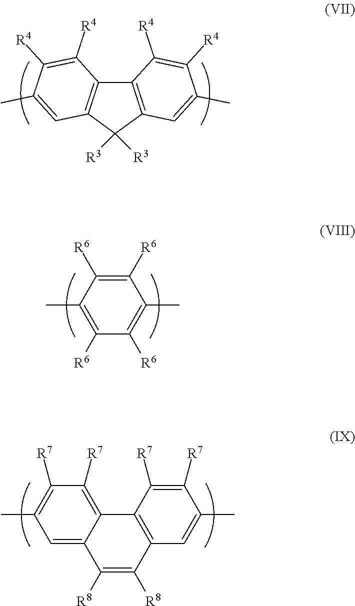

where: R³ in each occurrence is a substituent and R⁴, R⁶, R⁷ and R⁸ independently in each occurrence is H or a substituent.

Optionally, each R³ is selected from the group consisting of C₁₋₂₀ alkyl wherein one or more non-adjacent, non-terminal C atoms may be replaced with O, COO or CO; unsubstituted phenyl; and phenyl substituted with one or more C₁₋₁₂ alkyl groups wherein one or more non-adjacent, non-terminal C atoms of the alkyl groups may be replaced with O, COO or CO.

Optionally, R⁴, R⁶, R⁷ and R⁸ independently in each occurrence is H or a substituent selected from C₁₋₂₀ hydrocarbyl, optionally C₁₋₂₀ alkyl; unsubstituted phenyl; and phenyl substituted with one or more C₁₋₁₂ alkyl groups.

Polymers containing aromatic or heteroaromatic repeat units in the polymer backbone as described herein may be formed by methods including, without limitation, polymerization of monomers comprising leaving groups (groups other than H) that leave upon polymerization of the monomers; oxidative polymerization; and direct (hetero)arylation. Exemplary leaving groups include, without limitation: halogens, preferably bromine or iodine; sulfonic esters, for example tosylate or mesylate; and boronic acids and esters.

Exemplary polymerization methods include, without limitation, Yamamoto polymerization as described in, for example, T. Yamamoto, “Electrically Conducting And Thermally Stable pi-Conjugated Poly(arylene)s Prepared by Organometallic Processes”, Progress in Polymer Science 1993, 17, 1153-1205, the contents of which are incorporated herein by reference; Suzuki polymerization as described in, for example, WO 00/53656, WO 2003/035796, and U.S. Pat. No. 5,777,070, the contents of which are incorporated herein by reference; and direct (hetero)arylation as disclosed in, for example, Direct (Hetero)arylation Polymerization: Simplicity for Conjugated Polymers Synthesis”, Chem. Rev. 2016,116, 14225-14274, the contents of which are incorporated herein by reference.

Electrolyte

The electrolyte may be a dissolved salt or an ionic liquid. The electrolyte may be a solution of a salt having an organic or metal cation, for example lithium bis(trifluoromethylsulfonyl)imide (LiTFSI) or lithium hexafluorophosphate, in an organic solvent, optionally propylene carbonate.

Ionic liquids as described herein may be ionic compounds that are liquid at below 100° C. and at 1 atm pressure. Examples include, without limitation, compounds with an ammonium-, imidazolium-, phosphonium-, pyridinium-, pyrrolidinium- or sulfonium cation.

The ionic liquid may have an anion selected from: sulfonimide, optionally bis(trifluoromethane)sulfonimide (TFSI) and bis(fluorosulfonyl)imide) (FSI); borate, for example tetrafluoroborate; phosphate, for example hexafluorophosphate; and dicyanamide.

Examples of ionic liquids having a TFSI group are 1-ethyl-3-methyl imidazolium bis(trifluoromethane)sulfonimide (EMI-TFSI), triethylmethoxyethyl phosphonium bis(trifluoromethane)sulfonimide (TEMEP-TFSI), triethyl sulfonium bis(trifluoromethane)sulfonimide (TES-TFSI) or 1-butyl-1-methylpyrrolidinium bis(trifluoromethane)sulfonimide (BMP-TFSI), the latter being particularly preferable.

Electrode Additives

The anode and/or cathode as formed may consist of the n-type polymer and p-type polymer respectively. Preferably at least one of the anode and cathode, and more preferably both of the anode and cathode, comprise one or more conductive carbon materials. Conductive carbon materials may be selected from, without limitation, one or more of the group consisting of carbon black, carbon fiber, graphite, and carbon nanotubes. Preferably, the BET specific surface area of the conductive carbon material is in the range of 10 m²/g to 3000 m²/g. In some embodiments, the anode and/or cathode as formed may contain an electrolyte.

Current Collectors

The anode and cathode current collectors each independently comprise or consist of a layer of conductive material, for example a metal such as copper or aluminum; a conductive organic polymer such as poly(ethylene dioxythiophene) or polyaniline; or an inorganic conductive compound such as a conductive metal oxide, for example indium tin oxide. Each current collector may be supported on a suitable substrate, for example a glass or plastic substrate.

Battery Formation

A battery cell as described herein may be formed by applying the n-type polymer to the surface of an anode current collector to form the anode; applying the p-type polymer to the surface of a cathode current collector to form the cathode; placing a separator between the anode and cathode; and pressing the anode and cathode together.

The n-type polymer and/or p-type polymer may be deposited as a component of a composition comprising one or more additives as described above to form a composite electrode. The composition may be deposited from a formulation comprising the composition dispersed in one or more solvents by any suitable coating method including, without limitation, doctor blade coating followed by evaporation of the one or more solvents.

Surprisingly, the inventors have found that an anode or cathode film formed by depositing a composition comprising the n-type polymer or the p-type polymer (depending on whether an anode or a cathode is being formed), a conductive carbon material, a solvent and an electrolyte has improved performance compared to forming the anode or the cathode film by depositing a composition that does not include the electrolyte.

In some embodiments of the present disclosure, anode films were prepared on a current collector by depositing onto a current collector a composition comprising: an n-type polymer, a conductive carbon material, a solvent and an electrolyte. Similarly, in some embodiments, cathode films were prepared on a current collector by depositing onto a current collector a composition comprising: a p-type polymer, a conductive carbon material, a solvent and an electrolyte. In both instances, the electrolyte comprises a non-volatile liquid, for example an ionic liquid, a salt dissolved in a second solvent, where the solvent dissolving the salt has a much higher boiling point than that of the composition solvent and/or the like.

In the deposition of the anode and cathode materials, the solvent evaporates, but the non-volatile electrolyte liquid remains in the anode/cathode film deposited on the current collector. Subsequently, when the battery comprising the deposited anode/cathode film is charged, the electrolyte can move in and out of the anode/cathode film through the channels formed by its presence during the deposition/drying process. Scanning electron microscopy was used to identify the presence of these channels in the anode/cathode film.

Battery performance for batteries comprising the anode/cathode films with electrolyte/electrolyte channels was found to be markedly improved compared to batteries comprising conventional anode/cathode films absent the electrolyte/electrolyte channels. It is believed that this improvement in performance is due to the electrolyte moving through the electrolyte channels during battery operation.

Measurements

Square wave voltammetry measurements as described herein may be performed using a CHI660D Electrochemical workstation with software (IJ Cambria Scientific Ltd)), a CHI 104 3 mm glassy carbon disk working electrode (IJ Cambria Scientific Ltd)); a platinum wire auxiliary electrode; an Ag/AgCl reference electrode (Havard Apparatus Ltd); acetonitrile as cell solution solvent (Hi-dry anhydrous grade-ROMIL); toluene as sample preparation solvent (Hi-dry anhydrous grade); ferrocene as reference standard (FLUKA); and tetrabutylammoniumhexafluorophosphate (FLUKA) as cell solution salt. For sample preparation, the polymer is spun as thin film (˜20 nm) onto the working electrode.

The measurement cell contains the electrolyte, a glassy carbon working electrode onto which the sample is coated as a thin film, a platinum counter electrode, and a Ag/AgCl reference glass electrode. Ferrocene is added into the cell at the end of the experiment as reference material (LUMO (ferrocene)=−4.8 eV).

### POLYMER SYNTHESIS

Polymer Examples 1-4 and Comparative Polymer Example 1 were formed according to Scheme 1 using the monomer units as detailed in Table 1.

### Polymer Example 1

A 3-necked round-bottomed flask, equipped with a magnetic stirrer, Dean-stark apparatus, condenser, nitrogen inlet and exhaust was charged with naphthalene-1,5-diamine (15 g, 94.8 mmol) and toluene (75 mL). Then terephthalaldehyde (12.7 g, 94.8 mmol) was taken in toluene (75 mL) and it was added to the reaction flask. The reaction was refluxed under Dean-Stark condition for 24 h with azeotropic water removal. The orange solid formed was recovered by filtration of the warm solution and dried to get 16 g of crude material. The solid was triturated with THF (160 ml) for 4 h at 28° C. The solid was filtered and dried in a vacuum oven at 50° C. to afford 13 g of Polymer example 1 as an orange solid. CHN analysis: C: 82.82, H: 4.829: 10.78 (expected: C: 84.35, H: 4.72, N: 10.93).

### Polymer Example 2

The same procedure as for Polymer example 1 but using benzene-1,3-diamine (15 g, 138 mmol) as the diamino moiety with an equimolar amount of terephthalaldehyde (18.5 g, 138 mmol) to afford 6 g of Polymer example 2 as a brown solid. CHN analysis: C: 79.50, H: 4.973: N: 12.67 (expected: C: 81.53, H: 4.89, N: 13.58).

### Polymer Example 3

The same procedure as for Polymer example 1 but using 9,9′-spirobi[fluorene]-2,2′,7,7′-tetraamine (4 g, 10.6 mmol, synthesized according to Wuest et al., J. Org. Chem., Vol. 69, No. 6, 2004) and terephthalaldehyde (2.84 g, 21.2 mmol) with a mixture of toluene (150 ml) and DMF (150 ml) This was refluxed under Dean-Stark at 135° C. for 24 h with azeotropic water removal. The orange solid formed was recovered by filtration of the warm solution and dried to get 6.3 g of crude material.

The solid was triturated four times with THF (150 ml) at room temperature following than two trituration with DCM (150 ml) at 45° C. The solid was filtered and dried in a vacuum oven at 75° C. to afford 5.12 g of Polymer example 3 as an orange solid. CHN analysis: C: 81.34, H: 4.475, N: 9.3 (expected: C: 85.99, H: 4.22, N: 9.78).

### Polymer Example 4

A 100 ml 3-necked round-bottomed flask, equipped with a magnetic stirrer, condenser, nitrogen inlet and exhaust was charged with benzene-1,3-diamine (5 g, 46.2 mmol) and ethanol (40 mL) the solution was stirred for 10 minutes. Isophthalaldehyde (6.19 g, 46.2 mmol) was added to the reaction mixture at 25° C. followed by acetic acid (554 mg, 9.24 mmol) and to the reaction mixture was stirred at reflux ° C. for 18 h.

The solid was filtered and washed with ethanol (100 ml) to obtain 10 g of crude material. The crude product was triturated for 3 h in THF (150 ml) at 75° C., filtered and dried in a vacuum oven at 50° C. to afford 3 g of Polymer example 4 as a black solid. CHN analysis: C: 71.98, H: 5.13, N: 13.91 (expected: C: 81.53, H: 4.89, N: 13.58).

### Comparative Example 1

Comparative polymer example 1 was prepared according to Castillo-Martinez et Al, Angew. Chem. Int. Ed., 53: 5341-5345.

TABLE 1

| Polymer | Di-amino Unit | Di-aldehyde Unit | Polymer Structure |
|---|---|---|---|
| Example 1 | 1,5-diaminoaphthalene | p-terephthalaldehyde | 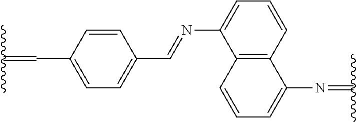 [SMILES: *=Cc1ccc(/C=N/c2cccc3c(N=*)cccc23)cc1] |
| Example 2 | m-phenylenediamine | p-terephthalaldehyde | 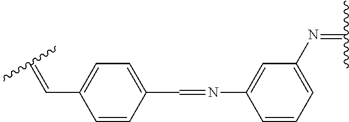 [SMILES: *=Cc1ccc(C=Nc2cccc(N=*)c2)cc1] |
| Example 3 | 2,2′,7,7′- tetraaminospirobifluor- ene | p-terephthalaldehyde | 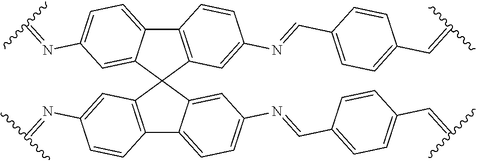 [SMILES: *=Cc1ccc(/C=N/c2ccc3c(c2)C2(c4cc(N=*)ccc4-3)c3cc(N=*)ccc3-c3ccc(/N=C/c4ccc(C=*)cc4)cc32)cc1] |
| Example 4 | m-phenylenediamine | m- terephthalaldehyde | 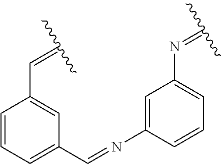 [SMILES: *=Cc1cccc(C=Nc2cccc(N=*)c2)c1] |
| Comparative Example 1 | p-phenylenediamine | p-terephthalaldehyde | 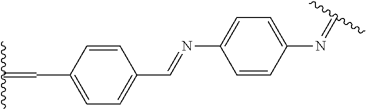 [SMILES: *=Cc1ccc(/C=N/c2ccc(N=*)cc2)cc1] |

The highest occupied molecular orbital (HOMO) and lowest occupied molecular orbital (LUMO) energies (Table 2) of examples 1-4 and comparative example 1 were calculated from oligomers using density functional theory (DFT) calculation using the B3LYP/6-31G* model.

TABLE 2

| | | | Maximum | Maximum |
|---|---|---|---|---|
| | | | Theoretical | Theoretical |
| | HOMO | LUMO | Specific Capacity | Specific Capacity |
| Polymer | (QC- | (QC- | (1 charge per | (2 charges per |
| Example | DFT) | DFT) | unit, mAh/g) | unit, mAh/g) |
| Example 1 | −5.27 | −2.18 | 105 | 210 |
| Example 2 | −5.79 | −2.14 | 130 | 260 |
| Example 3 | −5.63 | −1.70 | 94 | 188 |
| Example 4 | −5.31 | −2.29 | 130 | 260 |
| Comparative | −4.35 | −1.86 | 130 | 260 |
| Example 1 | | | | |

Maximum theoretical specific capacity (mAh/g) is determined from n charges per repeat unit molecular weight and Faraday's constant (26801 mAh/mol):

$$n * \frac{26801 ( \frac{mAh}{mol} )}{Repeat unit MW ( \frac{g}{mol} )}$$

### Battery Example 1

A battery having the following structure was formed:
Al current collector/Anode/Separator/Cathode/Al current collector

An anode formulation was prepared by blending 20 mg of Polymer Example 1 and 16 mg Super P® Carbon Black (commercially available from Imerys (TIMCAL)) and mixing using a pestle and mortar with 0.4 ml of a solution of PVDF-HFP (1 wt. %) in dimethylsulphoxide (DMSO) until a smooth paste was obtained. The paste composition by weight was [Polymer Example 1:Super P® Carbon Black:PVDF-HFP] weight ratio of [0.5:0.4:0.1].

A cathode formulation was prepared in the same way except that p-type Polymer 1, illustrated below, was used instead of Polymer Example 1 and PVDF-HFP and the solvent used was o-dichlorobenzene and 1-Butyl-1-methylpyrrolidinium bis(trifluoromethylsulfonyl)imide (BMP-TFSI) was added as a 5 wt. % solution in o-dichlorobenzene (4 mg, 80 μL) after a smooth paste is obtained from the polymer carbon and solvent mixing resulting in a final paste formulation [p-type Polymer 1:Super P® Carbon Black:BMP-TFSI] of [0.5:0.4:0.1].

The p-type Polymer 1 is an AB copolymer “F8-TFB” of formula:

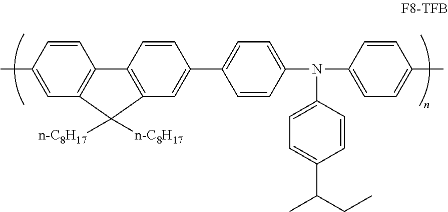

The p-type Polymer 1 has a HOMO of −5.2 eV and a LUMO of −2.0 eV.

Two one-inch Al (150 nm on glass) slides were pressed together side by side and 2 layers of transparent 3M tape (2×50 μm thick) were put on each side to define a 3 cm² area (2.5×1.2 cm). The electroactive layer blend formulations were spread separately on one side of the Al substrate and a scalpel blade was used to spread the material evenly over the area. The tapes were peeled off and the electroactive layers were dried on a hotplate at 100° C. for 10 minutes. The loading (mg/cm²) was determined by weighing the plate before and after deposition of the film.

The composite electrodes on Al were dehydrated at 150° C. for 20 minutes on a hotplate in the glovebox, before assembly. Thereafter, filter paper (vacuum oven dried) soaked in ionic liquid (BMP-TFSI) was applied between the composite electrodes as a separator and clips were used to provide a firm contact in the sandwiched assembly.

For device testing, the clips were removed and the device (active area: 3 cm²) was placed into a sealed glass container and connected to a potentiostat (CHI660D Electrochemical workstation with software (IJ Cambria Scientific Ltd)). Galvanostatic charging was performed at 1 mA/cm², followed by a 60 s potentiostatic hold at 3V and galvanostatic discharge at 1 mA/cm²to 0V. The charge-discharge cycle was repeated for a total of 30 cycles followed by a further 10 cycles performed at the lower current density of 0.1 mA/cm² (charge and discharge) and the mid-point (nominal) voltage and area capacity was calculated for each cycle.

Battery Example 2 was prepared as described for Battery Example 1 except that Polymer Example 2 was used to form the anode in place of Polymer Example 1 and that ionic liquid 1-Butyl-1-methylpyrrolidinium bis(trifluoromethylsulfonyl)imide (BMP-TFSI) as a 5 wt. % solution in DMSO (4 mg, 80 μL) was added prior to mixing to obtain a smooth paste. The final paste formulation [Polymer Example 2:Super P® Carbon Black:BMP-TFSI: PVDF-HFP] of [0.45:0.36:0.09:0.09].

Battery Example 3 was prepared as described for Battery Example 1 except that Polymer Example 3 was used to form the anode in place of Polymer Example 1.

### Comparative Batteries 1.1-1.3

Comparative Battery 1.1 was prepared as described for Battery Example 2 except that Comparative Polymer Example 1 was used in the preparation of the anode formulation in place of Polymer Example 2 so that the weight ratio of [Comparative Polymer Example 1:Super P® Carbon Black:BMP-TFSI:PVDF-HFP] was [0.45:0.36:0.09:0.09]. Comparative Batteries 1.2-1.3 were prepared as described for Comparative Battery 1.1 but the loading (and/or the discharge current density at which measurements were taken) was varied.

TABLE 3

| | | Discharge | Specific | | Specific | |
|---|---|---|---|---|---|---|
| | Polymer | Current | Charge | Areal | Current | Nominal |
| | Loading | Density | Capacity | Capacity | Density | Voltage |
| Battery | (mg/cm²) | (mA/cm²) | (mAh/g) | (mAh/cm²) | (A/g) | (V) |
| Example 1 | 0.28 | 1 | 58 | 0.016 | 4 | 2.1 |
| Example 2 | 0.19 | 1 | 41 | 0.009 | 5 | 2.3 |
| Example 3 | 0.43 | 1 | 8 | 0.003 | 2 | 1.8 |
| Comparative | 0.18 | 1 | 67 | 0.012 | 5 | 2 |
| 1.1 | | | | | | |
| Comparative | 0.18 | 0.1 | 87 | 0.016 | 1 | 2.1 |
| 1.2 | | | | | | |
| Comparative | 0.28 | 1 | 29 | 0.008 | 4 | 1.8 |
| 1.3 | | | | | | |

With reference to Table 3, the nominal voltage of Battery Example 1 and 2 is 0.1-0.3 V higher than Comparative Battery 1.1 when discharged at the same current density and with a similar loading.

Furthermore, with reference to Table 3, it can be seen that battery examples according to the present invention are more resistant to a decrease in nominal voltage associated with higher loadings. In particular, Battery Example 1 exhibits a high nominal voltage of 2.1 V even at a loading of 0.28 mg/cm² which contrasts the lower nominal voltage exhibited by Comparative Battery 1.3 when using the same loading. Battery Example 3 exemplifies this trend further as the nominal voltage of 1.8V is obtained even when using the high loading of 0.43 mg/cm².

Without wishing to be bound by theory, the non-linear nature of the polymer examples of the present invention may prevent close packing of polymer chains thereby producing a morphology that allows improved material utilization and ion migration.

FIG. 2

Charge-discharge cycles as described above were carried out on Battery Examples 1 and 2 and Comparative Battery 1.2 at a current density of 0.1 mA/cm². The results are shown in FIG. 2. There is an increase of 0.11 V when using Battery Example 1 instead of Comparative Battery 1.2 and an increase of 0.22 V when using Battery Example 2 instead of Comparative Battery 1.2 when the batteries are discharged to 1.5V at the same area current density.

Although the present invention has been described in terms of specific exemplary embodiments, it will be appreciated that various modifications, alterations and/or combinations of features disclosed herein will be apparent to those skilled in the art without departing from the scope of the invention as set forth in the following claims.

1. A battery cell comprising an anode comprising an n-type polymer, a cathode comprising a p-type polymer and an electrolyte between the anode and the cathode wherein at least one of the n-type polymer and the p-type polymer comprises a repeat unit of formula (I): 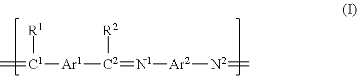
wherein:
R¹ and R² are each independently selected from the group consisting of hydrogen and C₁₋₂₀ alkyl, wherein one or more non-adjacent, non-terminal C atoms of the alkyl may be replaced with O, CO or COO; and
A¹ and Ar² are each independently an aromatic or heteroaromatic group which is unsubstituted or substituted with one or more substituents and at least one of Ar¹ and Ar² is selected from a group of formula (II) or a group of formula (III): 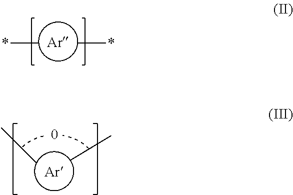
where Ar′ is an aromatic or heteroaromatic group which is unsubstituted or substituted with one or more substituents and θ is a bond angle which is not 180°; and
Ar″ is an aromatic or heteroaromatic group comprising two or more fused rings which is unsubstituted or substituted with one or more substituents and the linkages * of Ar″ are on different rings.

2. A battery cell according to claim 1, wherein Ar¹ and Ar² are each a C₆₋₂₀ arylene group.

3. A battery cell according to claim 1, wherein Ar¹ and Ar² are each a group of formula (II) or (III).

4. A battery cell according to claim 1, wherein Ar¹ is para-phenylene.

5. A battery cell according to claim 1, wherein Ar² is para-phenylene.

6. A battery cell according to claim 1, wherein at least one of Ar¹ and Ar² is a group of formula (III).

7. The battery cell of claim 6, wherein the group of formula (III) is meta-phenylene.

8. A battery cell according to claim 1, wherein at least one of Ar¹ and Ar² is a group of formula (II).

9. The battery cell according to claim 1, wherein the group of formula (II) is 1,5-naphthylene.

10. The battery cell according to claim 1, wherein R¹ is hydrogen.

11. The battery cell according to claim 1, wherein R² is hydrogen.

12. The battery cell according to claim 1 wherein formula (I) is:

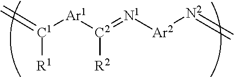

13. The battery cell according to claim 1, wherein at least one of the anode and cathode further comprises a conductive carbon material.

14. A composition comprising a polymer of formula (I) and one or more materials selected from the group comprising conductive carbon, electrolyte, binding agents, and an n-type polymer other than the polymer of formula (I) 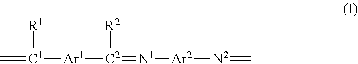
wherein:
R¹ and R² are each independently selected from the group consisting of hydrogen and C₁₋₂₀ alkyl, wherein one or more non-adjacent, non-terminal C atoms of the alkyl may be replaced with O, CO or COO; and
Ar¹ and Ar² are each independently an aromatic or heteroaromatic group which is unsubstituted or substituted with one or more substituents and at least one of Ar¹ and Ar² is selected from a group of formula (II) or a group of formula (III): 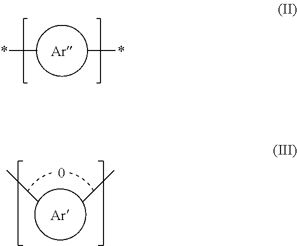
where Ar′ is an aromatic or heteroaromatic group which is unsubstituted or substituted with one or more substituents and θ is a bond angle which is not 180°; and
Ar″ is an aromatic or heteroaromatic group comprising two or more fused rings which is unsubstituted or substituted with one or more substituents and the linkages * of Ar″ are on different rings.

15. A composition according to claim 14, wherein the electrolyte is an ionic electrolyte.

16. A composition according to claim 14, wherein the conductive carbon is carbon black.

17. (canceled)

18. A formulation comprising a composition according to claim 14 dispersed in one or more solvents.

19-23. (canceled)

24. An anode for a battery comprising:
a current collector; and
an anode film deposited on the current collector, wherein the anode film comprises an the n-type polymer, a conductive carbon material and a plurality of conductive channels filled with a non-volatile electrolyte.

25. A battery cell, comprising the anode of claim 24.
